(19) United States
(12) Patent Application Publication
(10) Pub. No.: US 2016/0138626 A1
(43) Pub. Date: May 19, 2016

(54) Longitudinally Displaceable Clip Connection

(71) Applicant: Bayerische Motoren Werke Aktiengesellschaft, Muenchen (DE)

(72) Inventors: Johann VAN NIEKERK, Muenchen (DE); Mario ERNST, Geisenhausen (DE); Georg EDER, Moosburg (DE)

(21) Appl. No.: 15/002,584

(22) Filed: Jan. 21, 2016

Related U.S. Application Data
(63) Continuation of application No. PCT/EP2014/063317, filed on Jun. 25, 2014.

(30) Foreign Application Priority Data
Jul. 22, 2013 (DE) 10 2013 214 269.2

(51) Int. Cl. F16B 2/22; B60R 16/02

(52) U.S. Cl. CPC F16B 2/22; B60R 16/0215

(57) ABSTRACT

A clip connection includes a first component and a male fixing element which protrudes therefrom and has at least two balls or spherical portions that are arranged coaxially with one another and are connected together. A clip element is clipped onto the male fixing element. The clip element has two form-fitting elements which bear from the outside against the fixing element and engage between the balls or spherical portions. The form-fitting elements each extend in a longitudinal direction such that in a clipped-on state, the clip element is displaceable in translation in the longitudinal direction relative to the male fixing element and to the first component.

### CROSS REFERENCE TO RELATED APPLICATIONS

This application is a continuation of PCT International Application No. PCT/EP2014/063317, filed Jun. 25, 2014, which claims priority under 35 U.S.C. §119 from German Patent Application No. 10 2013 214 269.2, filed Jul. 22, 2013, the entire disclosures of which are herein expressly incorporated by reference.

### BACKGROUND AND SUMMARY OF THE INVENTION

The present invention relates to a clip connection including a first component, a male fixing element which has at least two balls of spherical sections that are disposed coaxially with respect to each other and connected to each other, and which projects from the first component, and a clip element that is clipped onto the male fixing element.

Such a clip connection is known from applicant's older, granted patent DE 10 2012 206 938 B3 (having U.S. counterpart US 2015/0033532 A1).

It is the object of the invention to create a clip connection that can compensate for certain position tolerances.

This and other objects are achieved according to the invention by providing a clip element including a first component, a male fixing element which comprises at least two balls or spherical sections that are disposed coaxially with respect to each other and connected to each other and which projects from the first component, and a clip element that is clipped onto the male fixing element. The clip element includes two form-fitting elements, which bear from the outside against the fixing element and engage between the balls or the spherical sections. Each of the form-fitting elements extends in a longitudinal direction, so that the clip element, when clipped on, can be displaced in a translatory manner relative to the fixing element and to the first component in the longitudinal direction.

The starting point of the invention is a clip connection having a first component, from which a “male fixing element” projects. The “male fixing element” includes at least two balls that are disposed coaxially with respect to each other and connected to each other (or two spherical sections that are disposed coaxially with respect to each other and connected to each other). The centers of the two balls or spherical sections are located on a straight line, which is preferably perpendicular to the first component or perpendicular to a tangential surface at the contact point of one of the two balls with the first component.

For example, the male fixation element can be made of steel, plastic material, in particular fiber-reinforced plastic material, or the like. The first component can likewise be made of steel, plastic material, in particular fiber-reinforced plastic material, or the like.

The male fixation element can be welded to the first component, for example, or be attached thereto in another manner, or else be integrally joined to the first component (for example by molding the first component and the “male fixing element” in one and the same operation).

A clip element is clipped onto the male fixing element projecting from the first component. A second component or a component to be fixed can be connected to the clip element, and consequently to the fixing element or the first component, by way of such a clip connection.

There are virtually an unlimited number of application possibilities for such clip connections. For example, in vehicle construction, such a clip connection can be used to fixedly clip a wiring harness to a car body element of the vehicle or to another vehicle component.

The core of the invention is that the clip element has at least two form-fitting elements, which bear from the outside against the fixing element, and more particularly in such a way that they positively engage between the balls or spherical sections, wherein each of the form-fitting elements extends in a longitudinal direction of the clip element, so that the clip element, when clipped on, can be displaced relative to the fixing element and to the first component in the longitudinal direction.

When considering the application example of attaching a wiring harness to such a male fixing element, it makes sense that it is advantageous when the clip connection is able to compensate for certain position tolerances of the clip elements in relation to the wiring harness, or of the male fixing element in relation to the first component. As a result of the “displacement degree of freedom” of the clip element in relation to the male fixing element, it is easily possible to compensate for such position tolerances.

A further advantage of the invention is that the clip element clipped onto the male fixing element can not only be displaced in relation to the male fixing element in the longitudinal direction of the form-fitting elements, but can also be rotated relative to the male fixing element. More particularly, it can be rotated about the axis on which the centers of the two balls or spherical elements are located. In this way, it is not only possible to compensate for translatory position tolerances, but also certain position tolerances in the rotational direction.

According to a further development of the invention, the clip element has a housing-like frame, from the inside of which the at least two form-fitting elements project. The form-fitting elements preferably project from mutually opposing longitudinal sides of the frame.

The frame thus preferably has an elongated design. For example, the frame can have the shape of a rectangle or a rectangle-like shape (for example, having rounded corners).

According to a further development of the invention, at least one of the form-fitting elements is designed to be flexible, for example in the form of a leaf spring.

Such a clip element can be produced particularly cost-effectively as an injection-molded part from plastic material.

According to a further development of the invention, it is provided that the clip element can be pushed onto the male fixing element in a push-on direction. The push-on direction is parallel to the straight line on which the centers of the two balls or of the spherical elements of the male fixing element are located.

At least one of the form-fitting elements can be disposed so as to project from the inside of the frame of the clip element counter to the push-on direction. It is therefore possible to achieve that a force that is required to push on or clip on the clip element is (considerably) smaller than a pull-off force that is required to pull off the clipped-on clip element.

Due to the design and arrangement or positioning of the form-fitting elements in relation to the frame and the balls or spherical elements, it is possible to set the push-on and pull-off forces. The form-fitting elements are preferably configured and disposed in such a way that the pull-off force is between 1.5 and 4.5 times greater than the push-on force. In particular, it may be provided that the pull-off force is approximately or exactly twice as high as the push-on or clip-on force.

According to a further development of the invention, it is provided that a holding arm, holding element or the like, via which a second component (or a component to be fixed) is connected to the clip element, projects from an outside of the frame of the clip element. This “holding element” can be wound into the wiring harness in the “wiring harness attachment application”.

Other objects, advantages and novel features of the present invention will become apparent from the following detailed description of one or more preferred embodiments when considered in conjunction with the accompanying drawing.

### BRIEF DESCRIPTION OF THE DRAWINGS

FIG. 1 is a schematic representation of an embodiment of the basic principle of the invention.

### DETAILED DESCRIPTION OF THE DRAWING

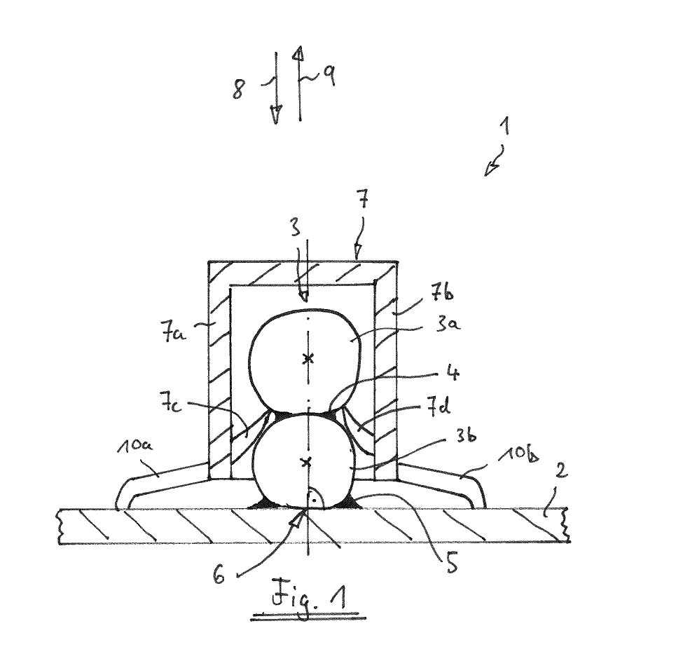

FIG. 1 shows a clip connection 1 comprising a first component 2, from which a male fixing element 3 projects. The male fixing element 3 is formed by two balls 3a, 3b connected to each other. For example, the two balls can be bonded to each other by way of a welded joint 4. The lower ball 3b is welded onto the first component 2 by way of a welded joint 5 in the exemplary embodiment shown in FIG. 1. As an alternative, the male fixing element 3 can also be connected to the component 2 in another manner, such as by way of a screw connection, a rivet connection or the like.

As is apparent from FIG. 1, the centers of the two balls are located on a shared straight line, which here is perpendicular to the tangential plane of the first component 2 at the contact point 6 of the lower ball 3b with the upper face of the first component 2.

A clip element 7 is clipped onto the male fixing element 3.

The clip element 7 comprises a frame having longitudinal sides 7a, 7b, which extend perpendicularly to the drawing plane, and broad sides, which extend parallel to the drawing plane and which are not visible in the sectional view shown here and connect the two longitudinal sides 7a, 7b to each other. By definition, the longitudinal sides 7a, 7b are longer than the broad sides of the frame of the clip element 7. Two flexible, leaf spring-like form-fitting elements 7c, 7d project from insides of the two mutually opposing longitudinal sides 7a, 7b.

When the clip element 7 is pushed onto the male fixing element 3 in a push-on direction 8, the two form-fitting elements 7c, 7d elastically bend upward and then spring back again until they are engaged between the two balls 3a, 3b, as shown in FIG. 1.

As is apparent from FIG. 1, the two form-fitting elements 7c, 7d project from the insides of the two longitudinal sides 7a, 7b in a direction that is opposite to the push-on direction 8, as a result of which the force that is required for pushing on in the push-on direction 8 is smaller than the force that is required for pulling the clip element 7 off in a pull-off direction opposite the push-on direction 8.

An aspect of the invention is that the form-fitting elements 7c, 7d extend in the longitudinal direction of the longitudinal sides 7a, 7b, which is to say perpendicularly to the drawing plane. This results in a longitudinal displacement degree of freedom. The clip element 7 can therefore be displaced perpendicularly to the drawing plane relative to the male fixing element 3, and therefore to the first component 2. Moreover, the clip element 7 could be rotated about the axis connecting the centers of the two balls 3a, 3b, resulting also in a certain rotatory degree of freedom.

For the sake of completeness, two spring-like arms 10a, 10b shall also be mentioned, which project flexibly from the longitudinal sides 7a, 7b of the clip element. The clip element 7 is supported on the upper face of the first component 2 by way of the elastic arms 10a, 10b.

Such a clip connection can be used in a plurality of application options. For example, such clip connections can be used to attach certain equipment components of a vehicle to the vehicle body or to other vehicle components. Alternative application options result for the furniture field, the “white goods” field, and the like.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A clip connection, comprising:
a first component;
a male fixing element comprising at least two balls or spherical sections disposed coaxially with respect to one another and connected to one another, the male fixing element projecting from the first component;
a clip element configured to be clipped onto the male fixing element, the clip element comprising two form-fitting elements that bear from outside against the male fixing element and engage between the at least two balls or spherical sections, and
wherein each of the two form-fitting elements extends in a longitudinal direction such that, when the clip element is clipped on the male fixing element, the clip element is displaceable in a translatory manner in the longitudinal direction relative to the male fixing element and the first component.

2. The clip connection according to claim 1, wherein the clip element comprises a housing frame, the at least two form-fitting elements projecting from an interior side of the housing frame.

3. The clip connection according to claim 2, wherein the housing frame has an elongated design.

4. The clip connection according to claim 3, wherein the housing frame has a substantially rectangular shape.

5. The clip connection according to claim 2, wherein the housing frame has a substantially rectangular shape.

6. The clip connection according to claim 2, wherein the at least two form-fitting elements are disposed on mutually opposing longitudinal sides of the housing frame.

7. The clip connection according to claim 5, wherein the at least two form-fitting elements are disposed on mutually opposing longitudinal sides of the housing frame.

8. The clip connection according to claim 1, wherein at least one of the two form-fitting elements is configured to be flexible.

9. The clip connection according to claim 8, wherein at least one of the two form-fitting elements is configured as a leaf spring.

10. The clip connection according to claim 7, wherein the at least one of the two form-fitting elements is configured as a leaf spring.

11. The clip connection according to claim 1, wherein
the clip element is pushable onto the male fixing element in a push-on direction, and
at least one of the two form-fitting elements is configured so as to be oriented counter to the push-on direction such that a force required to push-on the clip element is less than a force required to pull-off a clipped-on clip element.

12. The clip connection according to claim 2, wherein
the clip element is pushable onto the male fixing element in a push-on direction,
at least one of the two form-fitting elements projects from the inside of the housing frame in a direction at least partially counter to the push-on direction such that a force required to push-on the clip element is less than the force required to pull-off a clipped-on clip element.

13. The clip connection according to claim 12, wherein the two form-fitting elements are configured and arranged such that the force required to pull off the clipped-on clip element is between 1.5 and 4.5 times greater than the force required to push on the clip element.

14. The clip connection according to claim 11, wherein the two form-fitting elements are configured and arranged such that the force required to pull off the clipped-on clip element is between 1.5 and 4.5 times greater than the force required to push on the clip element.

15. The clip connection according to claim 2, wherein the clip element further comprises a holding element which projects from an exterior side of the housing frame of the clip element, the holding element being configured to connect with a second component.

16. The clip connection according to claim 15, wherein the first component is a vehicle component and the second component is a wiring harness of the vehicle.

17. The clip connection according to claim 1, wherein the clip element is a plastic component.

18. The clip connection according to claim 1, wherein the clip element is an injection molded component.
